(19) United States
(12) Patent Application Publication
(10) Pub. No.: US 2024/0394844 A1
(43) Pub. Date: Nov. 28, 2024

(54) Method and System for Deep Learning-Based MRI Reconstruction with Realistic Noise

(71) Applicant: University of Virginia Patent Foundation, Charlottesville, VA (US)

(72) Inventors: Quan Dou, Charlottesville, VA (US); Xue Feng, Zion Crossroads, VA (US); Craig H. Meyer, Charlottesville, VA (US)

(21) Appl. No.: 18/642,776

(22) Filed: Apr. 22, 2024

Related U.S. Application Data
(60) Provisional application No. 63/460,678, filed on Apr. 20, 2023.

(51) Int. Cl. G06T 5/60; G06T 5/70; G06T 11/00

(52) U.S. Cl. CPC G06T 5/60; G06T 5/70; G06T 11/006; G06T 2207/10088; G06T 2207/20081; G06T 2207/20084; G06T 2207/30004; G06T 2210/41; G06T 2210/52; G06T 2211/441

(57) ABSTRACT

A computer implemented method of training a deep learning convolutional neural network (CNN) to correct output magnetic resonance images includes acquiring magnetic resonance image (MRI) data for a region of interest of a subject and saving the MRI data in frames of k-space data. The method includes calculating ground truth image data from the frames k-space data. The method includes corrupting the k-space data with real noise additions into the lines of the k-space data and saving in computer memory, training pairs a ground truth frame and a corrupted frame with real noise additions. By applying the training pairs to a U-Net convolutional neural network, the method trains the U-Net to adjust output images by correcting the output images for the real noise additions.

### CROSS-REFERENCE TO RELATED APPLICATIONS

This application claims priority to and the benefit of U.S. provisional patent application No. 63/460,678, filed on Apr. 20, 2023, and titled Method and System for Deep-Learning Based MRI Reconstruction with Realistic Noise, the disclosure of which is hereby incorporated by reference herein in its entirety.

### STATEMENT OF GOVERNMENT RIGHTS

This invention was made with government support under grant number EB028773 awarded by the National Institutes of Health. The government has certain rights in the invention.

### BACKGROUND

Lyra-Leite [1], incorporated by reference herein, explains certain basics of magnetic resonance imaging (MRI). MRI is described therein in regard to the strong magnetic field B0 and gradient coils (i.e., Gx, Gy, Gz) that produce a gradient perturbation of B0 and frequency encode or phase encode the x, y, z spatial positions in any given scan image. A radio-frequency (RF) coil sends an excitation pulse to the imaging subject's body to yield net magnetization in an x-y plane for imaging in layers. The rotating magnetization generates an oscillating signal that can be detected. The frequency and phase of that oscillating signal can be detected for reconstructing the images of the energized region of interest. The resulting k-space of frequency or phase encoded data must be sampled and decomposed to give values to pixels or voxels of an image. Lyra-Leite [25] utilizes single value decomposition to reconstruct the images from less sample points within the encoded k-space maps.

These prior methods, however, need improvements in accuracy, signal to noise ratio, and overall quality of reconstruction.

In some embodiments, artificial intelligence and machine learning techniques are utilized to reconstruct MRI data into images that are useful to the naked eye. Machine Learning (ML) and Artificial Intelligence (AI) systems are in widespread use in customer service, marketing, and other industries. Machine learning is considered a subset of more general artificial intelligence operations, and AI endeavors may utilize numerous instances of machine learning to make decisions, predict outputs, and perform human-like intelligent operations. Machine learning protocols typically involve programming a model that instantiates an appropriate algorithm for a given computing environment and training the model on a particular data set or domain with known historical results. The results are generally known outputs of many combinations of parameter values that the algorithm accesses during training. The model uses numerous statistical and mathematical operations to learn how to make logical decisions and generate new outputs based on the historical training data. Machine learning (ML) includes, but is not limited to, a number of models such as neural networks, deep learning algorithms, support vector machines, data clustering, regression models, and Monte Carlo simulations. Other models may utilize linear regression, logistic regression, support vector machines, K-means clustering, classification models such as a binary classifier or a multi-class classifier, clustering models, anomaly detection, other supervised learning models, and even combinations of one or more machine language model types. Most of these take vectors of data as inputs.

The term “artificial intelligence,” therefore, includes any technique that enables one or more computing devices or comping systems (i.e., a machine) to mimic human intelligence. Artificial intelligence (AI) includes, but is not limited to, knowledge bases, machine learning, representation learning, and deep learning. The term “machine learning” is generally a subset of AI that enables a machine to acquire knowledge by extracting patterns from raw data.

The term “representation learning” may be used as a subset of machine learning that enables a machine to automatically discover representations needed for feature detection, prediction, or classification from raw data. Representation learning techniques include, but are not limited to, autoencoders.

The term “deep learning” may also be considered a subset of machine learning that enables a machine to automatically discover representations needed for feature detection, prediction, classification, etc. using layers of processing. Deep learning techniques include, but are not limited to, artificial neural network or multilayer perceptron (MLP). 3D UNet was originally proposed by Cicek et al. [17] for automatic segmentation of Xenopus (a highly aquatic frog) kidney. It has an encoder-decoder style architecture with skip connections between corresponding layers in encoding and decoding paths. This architecture is very popular for medical image segmentation. All the deep learning models used in this study have the same architecture, the 3D UNet. 3D in the name indicates that the input to this network is a 3D image. UNet refers to the structure of the network, which resembles the letter ‘U’. FIG. 5 shows the block representation of 3D UNet architecture.

Each convolutional block has two convolutions followed by max pooling. Every convolution is immediately followed by a rectified linear unit (ReLU) activation and batch normalization layer. Each deconvolutional block consists of two convolutions followed by a deconvolution to regain spatial dimension. Moreover, there are skip connections from the encoding path to decoding path at corresponding spatial dimensions. These are shown by green arrows. The very final convolution (shown by an arrow) that generates a three-dimensional feature map is followed by a soft-max activation in order to obtain a pseudo-random probability distribution at each pixel representing its class membership.

Machine learning models include supervised, semi-supervised, and unsupervised learning models. In a supervised learning model, the model learns a function that maps an input (also known as feature or features) to an output (also known as target or target) during training with a labeled data set (or dataset). In an unsupervised learning model, the model learns a function that maps an input (also known as feature or features) to an output (also known as target or target) during training with an unlabeled data set. In a semi-supervised model, the model learns a function that maps an input (also known as feature or features) to an output (also known as target or target) during training with both labeled and unlabeled data.

Some machine learning models are designed for a specific data set or domain and are highly expert at handling the nuances within that narrow domain. It is with respect to these and other considerations that the various aspects of the present disclosure as described below are presented.

In recent years, fast imaging techniques, such as parallel imaging [1-3] and compressed
sensing [4], have been widely employed to speed up the MRI acquisition. By under-sampling the k-space data, these methods effectively reduce the total scan time at the expense of signal-to-noise ratio (SNR). In a clinical setting, the under-sampled data can also be corrupted by a patient's motion. Recently, artificial intelligence, especially deep learning (DL), has shown great success in various medical imaging applications.

### SUMMARY

Other aspects and features according to the example embodiments of the disclosed technology will become apparent to those of ordinary skill in the art, upon reviewing the following detailed description in conjunction with the accompanying figures.

In one embodiment, a computer implemented method of training a deep learning convolutional neural network (CNN) to correct output magnetic resonance images includes acquiring magnetic resonance image (MRI) data for a region of interest of a subject and saving the MRI data in frames of k-space data. The method includes calculating ground truth image data from the frames k-space data. The method includes corrupting the k-space data with real noise additions into the lines of the k-space data and saving in computer memory, training pairs a ground truth frame and a corrupted frame with real noise additions. By applying the training pairs to a U-Net convolutional neural network, the method trains the U-Net to adjust output images by correcting the output images for the real noise additions.

A method of using the trained U-Net allows for correcting MRI images with the method.

An associated system utilizes a computer with image processing software to perform the method of training and the method of using.

### BRIEF DESCRIPTION OF THE DRAWINGS

Reference will now be made to the accompanying drawings, which are not necessarily drawn to scale. The patent or application file contains at least one drawing executed in color. Copies of this patent or patent application publication with color drawing(s) will be provided by the Office upon request and payment of the necessary fee.

FIG. 1 is a system diagram illustrating an imaging system capable of implementing aspects of the present disclosure in accordance with one or more embodiments.

FIG. 2 is a diagram showing an example embodiment of a system with thermal therapy used with MRI, which is capable of implementing aspects of the present disclosure in accordance with one or more embodiments.

FIG. 3 is a computer architecture diagram showing a computing system capable of implementing aspects of the present disclosure in accordance with one or more embodiments.

FIG. 4 is a flow diagram showing operations of a method for converging a convolutional neural network to output enhanced magnetic resonance image data that has been corrected for real noise additions.

FIG. 5 is a PRIOR ART example of a deep learning convolutional neural network as described in Reference [17] herein.

FIG. 6 is a schematic flow chart illustrating steps of calculating and saving, in computer memory, training data including training pairs of frames of ground truth image data and frames of test data with noise incorporated therein.

FIG. 7A is a schematic illustration of training augmentation steps undertaken on the training pairs of FIG. 6.

FIG. 7B is a schematic illustration of a deep learning convolutional neural network in the form of a U-Net architecture according to this disclosure.

FIG. 8A is a graph of quantitative evaluation for structural similarity measurements (SSIM) for output images resulting from the U-Net architecture of FIG. 7B applied to different forms of acquired MRI image data.

FIG. 8B is a graph of quantitative evaluation in terms of Peak Signal-To-Noise Ration (PSNR) for output images resulting from the U-Net architecture of FIG. 7B applied to different forms of acquired MRI image data.

FIG. 9 is an example set of representative reconstruction image results on simulated data using the U-Net architecture of FIG. 8A.

FIG. 10 is an example set of representative reconstruction image results on in vivo data applied to the U-Net architecture of FIG. 8A.

### DETAILED DESCRIPTION

In some aspects, the disclosed technology relates to systems, methods, and computer-readable medium for magnetic resonance based skull thermometry. Although example embodiments of the disclosed technology are explained in detail herein, it is to be understood that other embodiments are contemplated. Accordingly, it is not intended that the disclosed technology be limited in its scope to the details of construction and arrangement of components set forth in the following description or illustrated in the drawings. The disclosed technology is capable of other embodiments and of being practiced or carried out in various ways.

It must also be noted that, as used in the specification and the appended claims, the singular forms “a,” “an” and “the” include plural referents unless the context clearly dictates otherwise. Ranges may be expressed herein as from “about” or “approximately” one particular value and/or to “about” or “approximately” another particular value. When such a range is expressed, other exemplary embodiments include from the one particular value and/or to the other particular value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the disclosed technology. Similarly, it is also to be understood that the mention of one or more components in a device or system does not preclude the presence of additional components or intervening components between those components expressly identified.

As discussed herein, a “subject” (or “patient”) may be any applicable human, animal, or other organism, living or dead, or other biological or molecular structure or chemical environment, and may relate to particular components of the subject, for instance specific organs, tissues, or fluids of a subject, may be in a particular location of the subject, referred to herein as an “area of interest” or a “region of interest.”

A detailed description of aspects of the disclosed technology, in accordance with various example embodiments, will now be provided with reference to the accompanying drawings. The drawings form a part hereof and show, by way of illustration, specific embodiments and examples. In referring to the drawings, like numerals represent like elements throughout the several figures.

This disclosure presents a deep-learning based (DL-based) method for brain MRI reconstruction with realistic “noise” that includes artifacts. Specifically, a deep neural network was designed to reduce three types of imaging artifacts: (1) Additive complex Gaussian noise, (2) In-plane motion artifacts, and (3) Parallel imaging artifacts.

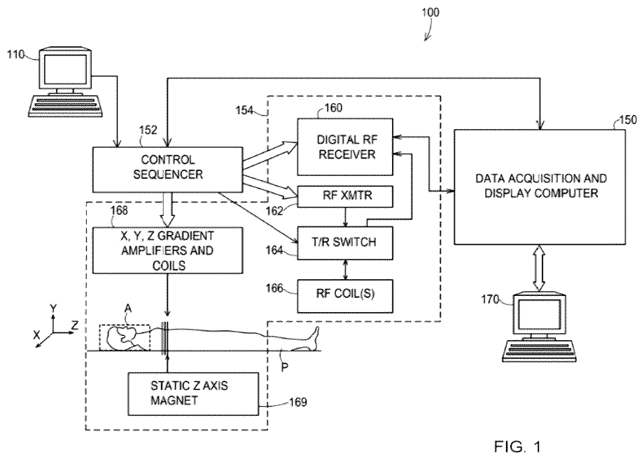

FIG. 1 is a system diagram illustrating an imaging system capable of implementing aspects of the present disclosure in accordance with one or more example embodiments. FIG. 1 illustrates an example of a magnetic resonance imaging (MRI) system 100, including a data acquisition and display computer 150 coupled to an operator console 110, an MRI real-time control sequencer 152, and an MRI subsystem 154. The MRI subsystem 154 may include XYZ magnetic gradient coils and associated amplifiers 168, a static Z-axis magnet 169, a digital RF transmitter 162, a digital RF receiver 160, a transmit/receive switch 164, and RF coil(s) 166. The MRI subsystem 154 may be controlled in real time by control sequencer 152 to generate magnetic and radio frequency fields that stimulate magnetic resonance phenomena in a subject P to be imaged, for example to implement magnetic resonance imaging sequences in accordance with various embodiments of the present disclosure. Reconstructed images, such as contrast-enhanced image(s) of an area of interest A of the subject P may be shown on display 170.

The area of interest A shown in the example embodiment of FIG. 1 corresponds to a head region of subject P, but it should be appreciated that the area of interest for purposes of implementing various aspects of the disclosure presented herein is not limited to the head area. It should be recognized and appreciated that the area of interest in various embodiments may encompass various areas of subject P associated with various physiological characteristics, such as, but not limited to the head and brain region, chest region, heart region, abdomen, upper or lower extremities, or other organs or tissues. Various aspects of the present disclosure are described herein as being implemented on portions of the skeletal system of human subjects, for example cortical bone tissue.

It should be appreciated that any number and type of computer-based medical imaging systems or components, including various types of commercially available medical imaging systems and components, may be used to practice certain aspects of the present disclosure. Systems as described herein with respect to imaging are not intended to be specifically limited to the particular system shown in FIG. 1. Likewise, systems as described herein with respect to the application of localized energy for heating certain areas for thermal treatment are not intended to be specifically limited to the particular systems shown or described below.

One or more data acquisition or data collection steps as described herein in accordance with one or more embodiments may include acquiring, collecting, receiving, or otherwise obtaining data such as imaging data corresponding to an area of interest. By way of example, data acquisition or collection may include acquiring data via a data acquisition device, receiving data from an on-site or off-site data acquisition device or from another data collection, storage, or processing device. Similarly, data acquisition or data collection devices of a system in accordance with one or more embodiments of the present disclosure may include any device configured to acquire, collect, or otherwise obtain data, or to receive data from a data acquisition device within the system, an independent data acquisition device located on-site or off-site, or another data collection, storage, or processing device.

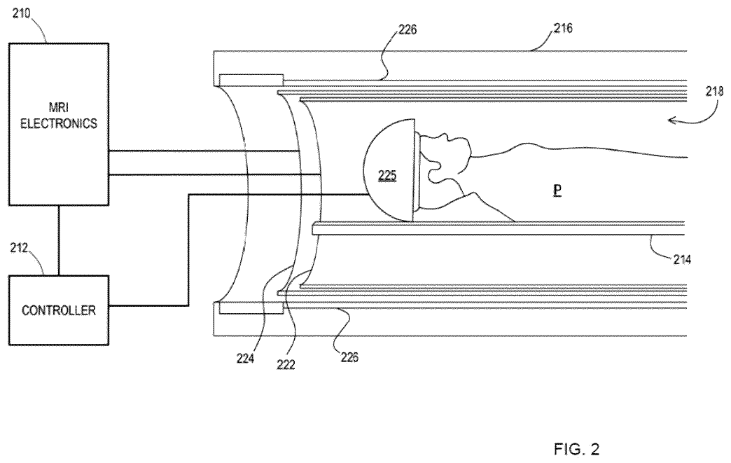

FIG. 2 is a diagram showing an embodiment of a system with focused ultrasound (FUS) used with MRI, each of which is capable of implementing aspects of the present disclosure in accordance with one or more embodiments. The MRI system may comprise one or more components of the system 100 shown in FIG. 1. As shown, RF coils 222, gradient coils 224, static Z axis magnet 226, and magnetic housing 216 surround the patient P when the patient is positioned on the table 214 inside of the MRI bore 218. A controller 212 communicates with MRI system electronics 210 as well as the FUS device (225). The MRI system electronics 210 can include one or more components of the MRI subsystem 154 shown in FIG. 23. A user computer (not shown) may communicate with the controller 212 for control of the MRI system and FUS device functions.

In FIG. 2, a type of FUS device 225 surrounds the patient's head, as may be used for thermal therapy applied to tissues of or near the brain. The device 225 may have multiple ultrasound transducers for applying focused energy to particular target areas of interest of the head of the patient. The device 225 can be configured to apply localized energy to heat a targeted region within the area of interest A which includes tissues of or near the brain. As a result, heating may occur in bone tissues, such as that of the skull. The MRI components of the system (including MRI electronics 210) are configured to work within a larger MRI system to acquire magnetic resonance data and for reconstructing images of all or regions of the area of interest as well as temperature-related data. The temperature data may include a temperature at a targeted region and/or a temperature at a reference region. The temperature data may be used to monitor the effectiveness and safety of the thermal therapy treatment and adjust treatment settings accordingly.

The targeted region may include bone tissue, which as described above, has a short T2/T2*. Control of the application of the focused energy via the controller 212 may be managed by an operator using an operator console (e.g., user computer). The controller 212 (which, as shown is also coupled to MRI electronics 210) may also be configured to manage functions for the application and/or receiving of MR signals. For example, the controller 212 may be coupled to a control sequencer such as the control sequencer 152 shown in FIG. 1.

Although the FUS device 225 shown in the embodiment of FIG. 2 utilize ultrasound transducer(s) as the source for delivering localized energy to an area of interest, it should be appreciated that other types of devices may alternatively be used without departing from the patentable scope of the present disclosure. Other possible types of thermal treatment/application devices that may be utilized include laser and/or RF ablation devices, or other devices adapted to heat a target tissue.

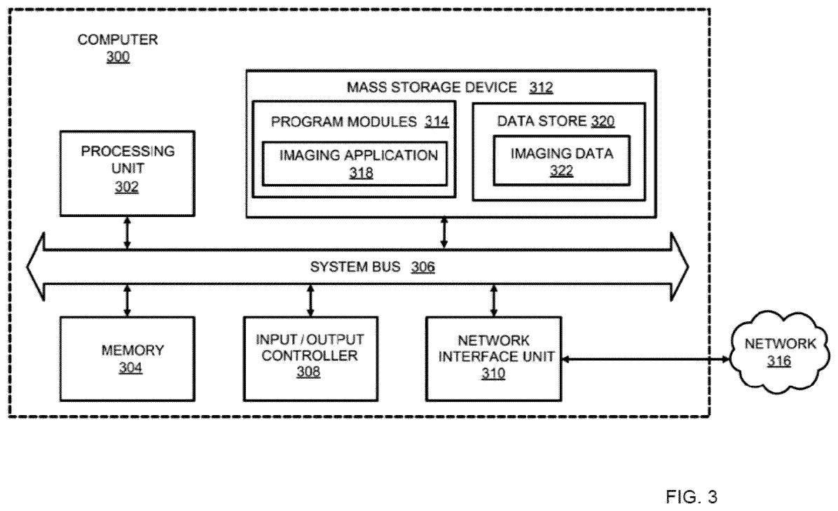

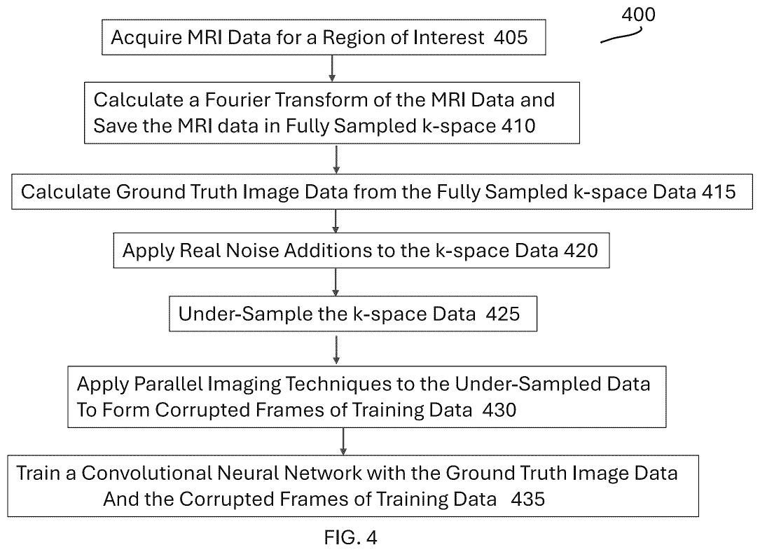

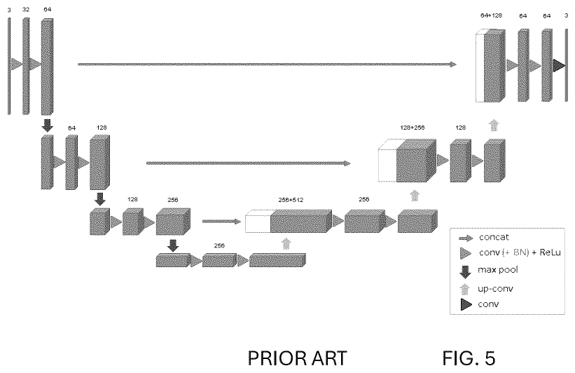

FIG. 3 is a computer architecture diagram showing a computing system capable of implementing aspects of the present disclosure in accordance with one or more embodiments described herein. A computer 300 may be configured to perform one or more specific steps of a method and/or specific functions for a system. The computer may be configured to perform one or more functions associated with embodiments illustrated in one or more of the figures herein. For example, the computer 300 may be configured to perform aspects described herein for implementing the pulse sequences shown and for various aspects of magnetic resonance imaging and related signal and temperature monitoring shown in the figures. It should be appreciated that the computer 300 may be implemented within a single computing device or a computing system formed with multiple connected computing devices. The computer 300 may be configured to perform various distributed computing tasks, in which processing and/or storage resources may be distributed among the multiple devices. The data acquisition and display computer 150 and/or operator console 110 of the system shown in FIG. 1, and the controller 212 and/or MRI electronics 210 of the system shown in FIG. 2, may include one or more components of the computer 300.

As shown, the computer 300 includes a processing unit 302 (“CPU”), a system memory 304, and a system bus 306 that couples the memory 304 to the CPU 302. The computer 300 further includes a mass storage device 312 for storing program modules 314. The program modules 314 may be operable to perform functions associated with one or more embodiments described herein. For example, when executed, the program modules can cause one or more medical imaging devices, localized energy producing devices, and/or computers to perform functions described herein for implementing the pulse sequence shown in FIG. 3, the method shown in FIG. 1, and for various aspects of magnetic resonance imaging and related signal and temperature monitoring and analysis shown in the figures herein. The program modules 314 may include an imaging application 318 for performing data acquisition and/or processing functions as described herein, for example to acquire and/or process image data corresponding to magnetic resonance imaging of an area of interest. The computer 300 can include a data store 320 for storing data that may include imaging-related data 322 such as acquired data from the implementation of magnetic resonance imaging pulse sequences in accordance with various embodiments of the present disclosure.

The mass storage device 312 is connected to the CPU 302 through a mass storage controller (not shown) connected to the bus 306. The mass storage device 312 and its associated computer-storage media provide non-volatile storage for the computer 300. Although the description of computer-storage media contained herein refers to a mass storage device, such as a hard disk, it should be appreciated by those skilled in the art that computer-storage media can be any available computer storage media that can be accessed by the computer 300.

By way of example and not limitation, computer storage media (also referred to herein as “computer-readable storage medium” or “computer-readable storage media”) may include volatile and non-volatile, removable and non-removable media implemented in any method or technology for storage of information such as computer-storage instructions, data structures, program modules, or other data. For example, computer storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 300. “Computer storage media”, “computer-readable storage medium” or “computer-readable storage media” as described herein do not include transitory signals.

According to various embodiments, the computer 300 may operate in a networked environment using connections to other local or remote computers through a network 316 via a network interface unit 310 connected to the bus 306. The network interface unit 310 may facilitate connection of the computing device inputs and outputs to one or more suitable networks and/or connections such as a local area network (LAN), a wide area network (WAN), the Internet, a cellular network, a radio frequency (RF) network, a Bluetooth-enabled network, a Wi-Fi enabled network, a satellite-based network, or other wired and/or wireless networks for communication with external devices and/or systems.

The computer 300 may also include an input/output controller 308 for receiving and processing input from any of a number of input devices. Input devices may include one or more of keyboards, mice, stylus, touchscreens, microphones, audio capturing devices, and image/video capturing devices. An end user may utilize the input devices to interact with a user interface, for example a graphical user interface, for managing various functions performed by the computer 300. The input/output controller 308 may be configured to manage output to one or more display devices for displaying visually representations of data, such as display monitors/screens that are integral with other components of the computer 300 or are remote displays.

The bus 306 may enable the processing unit 302 to read code and/or data to/from the mass storage device 312 or other computer-storage media. The computer-storage media may represent apparatus in the form of storage elements that are implemented using any suitable technology, including but not limited to semiconductors, magnetic materials, optics, or the like. The computer-storage media may represent memory components, whether characterized as RAM, ROM, flash, or other types of technology. The computer storage media may also represent secondary storage, whether implemented as hard drives or otherwise. Hard drive implementations may be characterized as solid state, or may include rotating media storing magnetically-encoded information. The program modules 314, which include the imaging application 318, may include instructions that, when loaded into the processing unit 302 and executed, cause the computer 300 to provide functions associated with one or more embodiments illustrated in the figures. The program modules 314 may also provide various tools or techniques by which the computer 300 may participate within the overall systems or operating environments using the components, flows, and data structures discussed throughout this description.

Accelerating MRI acquisition is always in high demand, because long scan times could increase the potential risk of image degradation caused by patient motion. Generally, MRI reconstruction with higher under-sampling rates requires regularization terms, such as wavelet transformation and total variation transformation. One challenge of fast MRI is to recover the original image from under-sampled k-space data. Prior technologies, such as SENSE [2] exploits the knowledge of sensitivity maps, and GRAPPA [3] uses the learned weighted-coefficients from autocalibration signal (ACS) lines to estimate the missing k-space lines. Compressed sensing (CS) [4] uses the idea that data could be compressed if under-sampled artifacts are incoherent. Therefore, it introduces the concept of sparsity, achieved by regularization terms. L1-ESPIRiT [5] also includes regularization terms in soft-SENSE reconstruction to iteratively find the optimal solution. After the PnP prior [5] was first proposed by Venkatakrishnan et al., there have been several studies applying this concept to MRI. Most of these studies focus on the convolutional neural network, CNN, algorithm to complete the denoising process of the PnP algorithm.

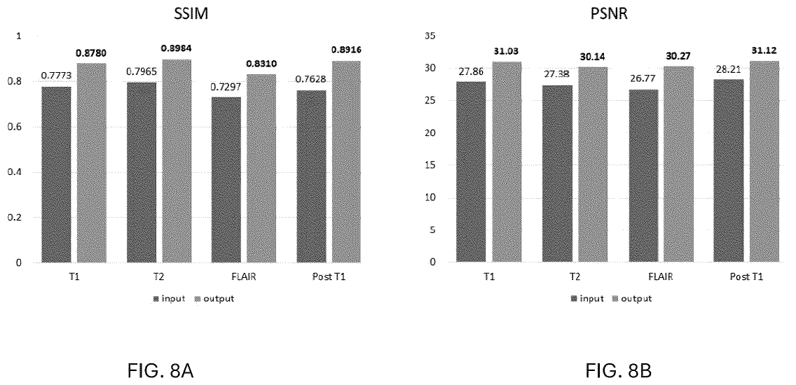

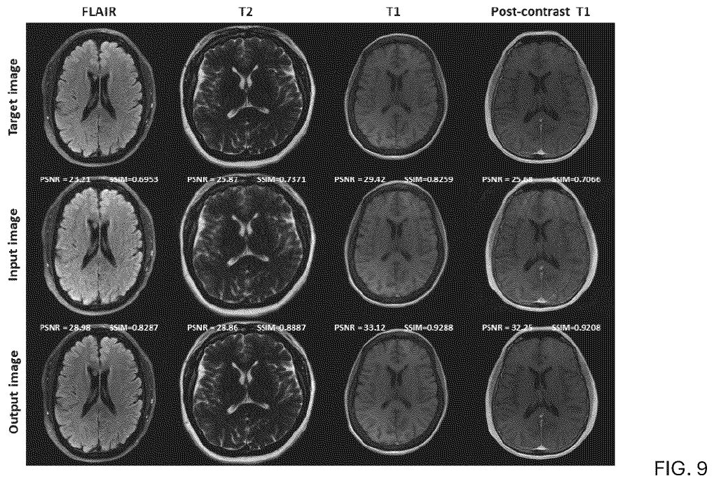

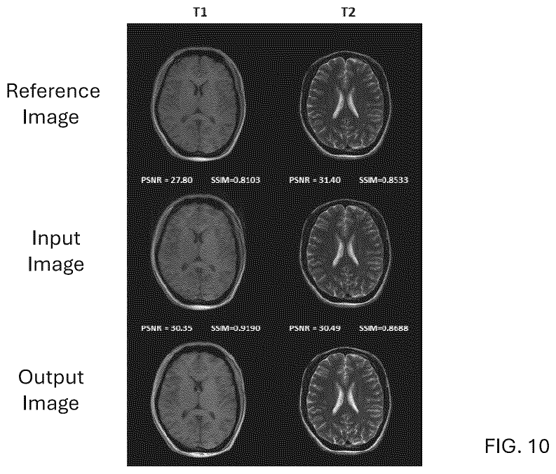

Fast imaging techniques can speed up MRI acquisition but can also be corrupted by noise, reconstruction artifacts, and motion artifacts in a clinical setting. A deep learning-based method of FIG. 8A and FIG. 89B has been developed and shown herein to reduce imaging noise and artifacts. A network trained with the supervised approach improved the image quality for both simulated data of FIG. 9 and in vivo data of FIG. 10.

In recent years, fast imaging techniques, such as parallel imaging [6-8] and compressed sensing [9], have been widely employed to speed up the MRI acquisition. By under-sampling the k-space data, these methods effectively reduce the total scan time at the expense of signal-to-noise ratio (SNR). In a clinical setting, the under-sampled data can also be corrupted by motion when the patient is not completely still during the magnetic resonance imaging procedure.

Recently, artificial intelligence, especially deep learning (DL), has shown great success in various medical imaging applications. This disclosure includes a deep learning based (DL-based) method for brain MRI reconstruction with realistic “noise” that includes artifacts. Specifically, a deep neural network was designed to reduce three types of imaging artifacts: (1) Additive complex Gaussian noise 625, 630, (2) In-plane motion artifacts 645, 650, and (3) Parallel imaging artifacts 665, 670.

To train a deep learning model through the supervised approach, a large number of training pairs are required. The fast MRI dataset [10] (https://fastmri.med.nyu.edu/) provides fully sampled multicoil brain MRI data for T1, post-contrast T1, T2, and FLAIR modalities in k-space, which is suitable for realistic noise simulation.

In the study of this disclosure, random complex Gaussian noise 625 was first generated and added to the multi-coil images 630. Then, a random motion profile 645 was synthesized, which includes in-plane translations and rotations. The multi-coil images were corrupted by manipulating the k-space lines based on the motion profile during a motion simulation 650. After under-sampling the k-space data 660 with a sampling mask 655 having a ratio between two (2) and four (4), inclusive, the simulated image with realistic noise was reconstructed with parallel imaging 662 by JSENSE [11] GRAPPA [8], or L1-ESPIRIT [12], where the JSENSE and L1-ESPIRiT implementations were from the SigPy Python package [13].

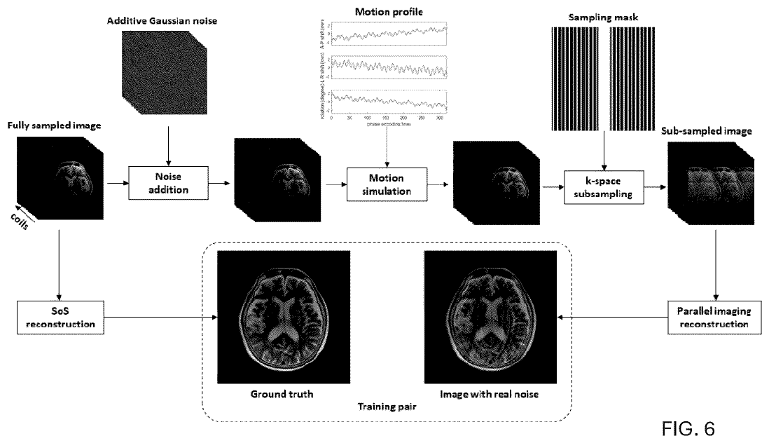

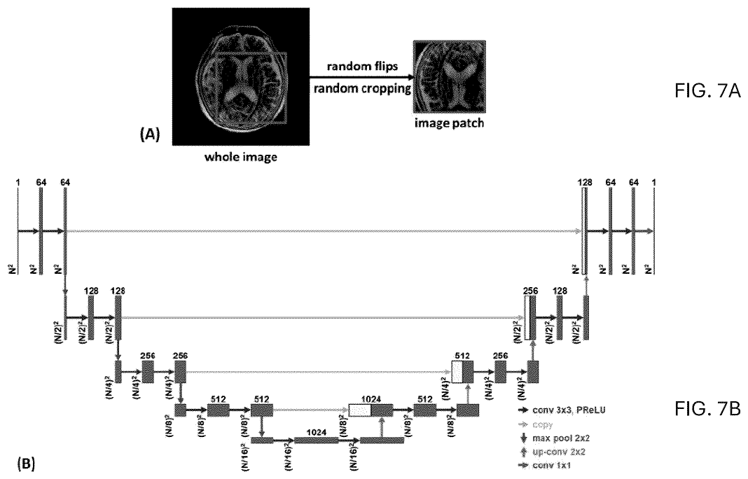

The ground truth 615 was calculated from the fully sampled multi-coil images 605 with a sum-of-squares (SoS) reconstruction 612, as shown in FIG. 6. FIG. 7A shows a cropping procedure to narrow down the region of interest (ROI) for enhanced reconstruction.

FIG. 7(B) shows the network architecture 700 used to reconstruct the image, even if the k-space data 660 was under-sampled. A two-dimensional U-Net (2D U-Net) [14] was used as a backbone network structure to remove imaging artifacts, where the convolutional kernel size is 3×3 and the activation function is a parametric rectified linear unit (PReLU). The input of the network is the magnitude image with realistic noise. The last layer of the network performs a 1×1 convolution and generates the output magnitude image. As noted, FIG. 7(A) shows one non-limiting example of training augmentation strategies. To reduce the probability of overfitting based on the global anatomy, random flips and random patch cropping were employed during training. The network was implemented in PyTorch [15] and trained to minimize the structural similarity index (SSIM) loss using Adam optimizer [16] with a learning rate of 0.0001 for 200 epochs. To evaluate the network performance, a structural similarity measurement (SSIM) and peak SNR (PSNR) between ground truth and network output were calculated and the results shown in FIG. 8A and FIG. 8B. In vivo T1 and T2 brain images of a healthy volunteer were acquired on a Siemens Prisma 3T scanner. The volunteer was first asked to keep still in the reference scan and then nod his/her head to corrupt the k-space data. The under-sampling ratio was set to 3 and the images were reconstructed using GRAPPA.

FIG. 8A and FIG. 8B show the quantitative evaluation results of the network performance on simulated dataset. The average SSIM and PSNR of the network output were increased for all four modalities. FIG. 9 shows representative slices from the simulated dataset. Compared to the input images with simulated noise, the output images showed reduced artifacts and improved image quality. FIG. 10 shows the network performance on in vivo brain images. The trained network effectively suppressed the motion artifacts, especially in the T1 image.

This disclosure illustrates a deep neural network method to reduce the realistic noise in brain MRI reconstruction. The noise simulation considered three widely used MRI reconstruction techniques and three types of imaging artifacts. Through the supervised training, image data can be corrected for more accurate and efficient output images.

### EXAMPLE EMBODIMENTS

In one non-limiting embodiment, a computer implemented method 400 of training a convolutional neural network 700 for reconstructing a magnetic resonance image with a computer having a processor, computer memory, and software configured to implement image processing functions includes acquiring magnetic resonance image (MRI) data 405 for a region of interest of a subject; saving the MRI data in frames of k-space data 410; calculating ground truth image data from the frames k-space data 415; corrupting the k-space data with real noise additions 420, wherein the real noise additions comprise at least one of added noise, simulated motion, or parallel imaging artifacts; saving in the computer memory, training pairs of image data comprising a ground truth frame 415 and a corrupted frame 430 with real noise additions; and applying the training pairs to a U-Net convolutional neural network to train the U-Net 435 to adjust output images by correcting the output images for the real noise additions. Calculating the ground truth image data may include a sum-of-squares reconstruction of the ground truth frame. Prior to forming the corrupted frame 430, the method may include under-sampling the k-space data 425 after corrupting the k-space data with the real noise additions. In non-limiting examples, calculating and saving the corrupted frame with real noise additions may be accomplished by parallel image reconstruction techniques. The parallel image reconstruction techniques may include at least two of JSENSE reconstruction, GRAPPA reconstruction, or L1-ESPIRIT reconstruction.

In another embodiment, a method of using a convolutional neural network for reconstructing a magnetic resonance image with a computer having a processor, computer memory, and software configured to implement image processing functions includes training a U-Net convolutional neural network with the computer by implementing computerized steps of acquiring magnetic resonance image (MRI) data 405 for a region of interest of a subject; saving the MRI data in frames of k-space data 410; calculating ground truth image data from the frames k-space data 415; corrupting the k-space data with real noise additions 420, wherein the real noise additions comprise at least one of added noise, simulated motion, or parallel imaging artifacts; saving in the computer memory, training pairs of image data comprising a ground truth frame 415 and a corrupted frame 430 with real noise additions; and applying the training pairs to a U-Net convolutional neural network to train the U-Net 435 to adjust output images by correcting the output images for the real noise additions. After the training, the method includes applying either simulated image data or in-vivo image data to the U-Net; and correcting the output images for instances of real noise additions.

Either the training method or the actual use of the method may include utilizing training augmentations to the k-space data. The training augmentations may include random flips of the k-space data and/or random cropping of the k-space data. Training a U-Net convolutional neural network may include training a two dimensional U-Net convolutional neural network. Again, the method includes under-sampling the k-space data after the real noise additions with a sampling mask to train the U-Net to correct images even if the images are under sampled. The corrupted images of the training steps may include applying parallel imaging reconstruction procedures to a sub-sampled k-space data set to form the corrupted frame. Applying the parallel imaging reconstruction procedures may include applying at least two of JSENSE reconstruction, GRAPPA reconstruction, or L1-ESPIRIT reconstruction.

In a computerized system embodiment of training a convolutional neural network for reconstructing a magnetic resonance image, the system includes a computer having a processor, computer memory, and software configured to implement image processing functions, wherein the software implements a method includes acquiring magnetic resonance image (MRI) data for a region of interest of a subject; saving the MRI data in frames of k-space data; calculating ground truth image data from the frames k-space data; corrupting the k-space data with real noise additions, wherein the real noise additions comprise at least one of added noise, simulated motion, or parallel imaging artifacts; saving in the computer memory, training pairs of image data comprising a ground truth frame and a corrupted frame with real noise additions; and applying the training pairs to a U-Net convolutional neural network to train the U-Net to adjust output images by correcting the output images for the real noise additions. Calculating the ground truth image data may be completed with a sum-of-squares reconstruction of the ground truth frame. Under-sampling the k-space data after corrupting the k-space data with the real noise additions provides for more realistic training sessions with corrupted frames that have been calculated and saved with real noise addition by parallel image reconstruction techniques. The trained U-Net may be used by applying either simulated image data or in-vivo image data to the U-Net and correcting the output images for instances of real noise additions.

These and other aspects of the disclosure are further set forth in the claims and the figures herein.

### REFERENCES

The following patents, applications and publications as listed below and throughout this document are hereby incorporated by reference in their entirety herein, and which are not admitted to be prior art with respect to the present invention by inclusion in this section.
[1] Lyra-Leite, D. M., da Costa, J. P. C. L. and Carvalho, J. L. A. “Improved MRI Reconstruction Using a Singular Value Decomposition Approximation”. In: Ingenieria, Vol. 17, No. 2, page 35-45.
[2] Pruessmann K P, et al. MRM 1999; 42:952-962.
[3] Griswold M A, et al. MRM 2002; 47:1202-1210.
[4] Lustig M, et al. MRM 2007; 58: 1182-1195.
[5] Uecker M, et al. MRM 2014; 71:990-1001.
[6] Pruessmann K P, Weiger M, Scheidegger M B, Boesiger P. SENSE: sensitivity encoding for fast MRI. Magn Reson Med. 1999 November; 42(5):952-62.
[7] Griswold M A, Jakob P M, Heidemann R M, Nittka M, Jellus V, Wang J, Kiefer B, Haase A.
Generalized autocalibrating partially parallel acquisitions (GRAPPA). Magn Reson Med. 2002 June; 47(6):1202-10.
[8] Lustig M, Pauly J M. SPIRiT: Iterative self-consistent parallel imaging reconstruction from arbitrary k-space. Magn Reson Med. 2010 August; 64(2):457-71.
[9] Lustig M, Donoho D, Pauly J M. Sparse MRI: The application of compressed sensing for rapid MR imaging. Magn Reson Med. 2007 December; 58(6):1182-95.
[10] Zbontar J, Knoll F, Sriram A, et al. fastMRL: An Open Dataset and Benchmarks for Accelerated MRI. 2018. arXiv:1811.08839 [cs.CV].
[11] Ying L, Sheng J. Joint image reconstruction and sensitivity estimation in SENSE (JSENSE). Magn Reson Med. 2007 June; 57(6):1196-202.
[12] Uecker M, Lai P, Murphy M J, Virtue P, Elad M, Pauly J M, Vasanawala S S, Lustig M.
ESPIRiT—an eigenvalue approach to autocalibrating parallel MRI: where SENSE meets GRAPPA. Magn Reson Med. 2014 March; 71(3):990-1001.
[13] Ong F, Lustig M. SigPy: A Python Package for High Performance Iterative Reconstruction.
In Proceedings of the 27th Annual Meeting of ISMRM, Montreal, Canada, 2019. p. 4819.
[14] Ronneberger O, Fischer P, Brox T. U-net: convolutional networks for biomedical image segmentation. 2015. arXiv:1505.04597 [cs.CV].
[15] Paszke A, Gross S, Massa F, et al. PyTorch: An Imperative Style, High-Performance Deep Learning Library. 2019. arXiv:1912.01703 [cs.LG].
[16] Kingma D P, Ba J. Adam: A Method for Stochastic Optimization. 2014. arXiv:1412.6980 [cs.LG].
[17] Çiçek, Özgün et al., 3D U-Net: Learning Dense Volumetric Segmentation from Sparse Annotation published in MICCAI 2016.

### CONCLUSION

The specific configurations, choice of materials and the size and shape of various elements can be varied according to particular design specifications or constraints requiring a system or method constructed according to the principles of the disclosed technology. Such changes are intended to be embraced within the scope of the disclosed technology. The presently disclosed embodiments, therefore, are considered in all respects to be illustrative and not restrictive. The patentable scope of certain embodiments of the disclosed technology is indicated by the appended claims, rather than the foregoing description.

1. A computer implemented method of training a convolutional neural network for reconstructing a magnetic resonance image with a computer having a processor, computer memory, and software configured to implement image processing functions, the method of training comprising:
acquiring magnetic resonance image (MRI) data for a region of interest of a subject;
saving the MRI data in frames of k-space data;
calculating ground truth image data from the frames k-space data;
corrupting the k-space data with real noise additions, wherein the real noise additions comprise at least one of added noise, simulated motion, or parallel imaging artifacts;
saving in the computer memory, training pairs of image data comprising a ground truth frame and a corrupted frame with real noise additions;
applying the training pairs to a U-Net convolutional neural network to train the U-Net to adjust output images by correcting the output images for the real noise additions.

2. The computer implemented method of claim 1, wherein calculating the ground truth image data comprises a sum-of-squares reconstruction of the ground truth frame.

3. The computer implemented method of claim 1, further comprising under-sampling the k-space data after corrupting the k-space data with the real noise additions.

4. The computer implemented method of claim 1, further comprising calculating and saving the corrupted frame with real noise addition by parallel image reconstruction techniques.

5. The computer implemented method of claim 4, wherein the parallel image reconstruction techniques comprise at least two of JSENSE reconstruction, GRAPPA reconstruction, or L1-ESPIRIT reconstruction.

6. A computer implemented method of using a convolutional neural network for reconstructing a magnetic resonance image with a computer having a processor, computer memory, and software configured to implement image processing functions, the method comprising:
training a U-Net convolutional neural network with the computer by implementing computerized steps comprising:
acquiring magnetic resonance image (MRI) data for a region of interest of a subject;
saving the MRI data in frames of k-space data;
calculating ground truth image data from the frames k-space data;
corrupting the k-space data with real noise additions, wherein the real noise additions comprise at least one of added noise, simulated motion, or parallel imaging artifacts;
saving in the computer memory, training pairs of image data comprising a ground truth frame and a corrupted frame with real noise additions;
applying the training pairs to the U-Net convolutional neural network to train the U-Net to adjust output images by correcting the output images for the real noise additions; and
applying either simulated image data or in-vivo image data to the U-Net; and
correcting the output images for instances of real noise additions.

7. The computer implemented method of claim 6, further comprising utilizing training augmentations to the k-space data.

8. The computer implemented method of claim 7, wherein the training augmentations comprise random flips of the k-space data and/or random cropping of the k-space data.

9. The computer implemented method of claim 6, wherein training a U-Net convolutional neural network comprises training a two dimensional U-Net convolutional neural network.

10. The computer implemented method of claim 6, further comprising under-sampling the k-space data after the real noise additions with a sampling mask.

11. The computer implemented method of claim 10, further comprising applying parallel imaging reconstruction procedures to a sub-sampled k-space data set to form the corrupted frame.

12. The computer implemented method of claim 11, wherein applying the parallel imaging reconstruction procedures comprises applying at least two of JSENSE reconstruction, GRAPPA reconstruction, or L1-ESPIRIT reconstruction.

13. A computerized system of training a convolutional neural network for reconstructing a magnetic resonance image, the computerized system comprising:
a computer having a processor, computer memory, and software configured to implement image processing functions, wherein the software implements a method comprising the following steps:
acquiring magnetic resonance image (MRI) data for a region of interest of a subject;
saving the MRI data in frames of k-space data;
calculating ground truth image data from the frames k-space data;
corrupting the k-space data with real noise additions, wherein the real noise additions comprise at least one of added noise, simulated motion, or parallel imaging artifacts;
saving in the computer memory, training pairs of image data comprising a ground truth frame and a corrupted frame with real noise additions;
applying the training pairs to a U-Net convolutional neural network to train the U-Net to adjust output images by correcting the output images for the real noise additions.

14. The computerized system of claim 13, wherein calculating the ground truth image data comprises a sum-of-squares reconstruction of the ground truth frame.

15. The computerized system of claim 13, further comprising under-sampling the k-space data after corrupting the k-space data with the real noise additions.

16. The computerized system of claim 13, further comprising calculating and saving the corrupted frame with real noise addition by parallel image reconstruction techniques.

17. A method of using the computerized system of claim 13 by:
applying either simulated image data or in-vivo image data to the U-Net; and
correcting the output images for instances of real noise additions.
